(19) United States
(12) Patent Application Publication
(10) Pub. No.: US 2014/0272899 A1
(43) Pub. Date: Sep. 18, 2014

(54) CIVICS TESTING

(71) Applicant: Nethercutt Enterprise, LLC, Mclean, VA (US)

(72) Inventors: George Nethercutt, Spokane, WA (US); William Marks, Hollywood, FL (US)

(73) Assignee: Nethercutt Enterprise, LLC, Mclean, VA (US)

(21) Appl. No.: 14/212,716

(22) Filed: Mar. 14, 2014

Related U.S. Application Data
(60) Provisional application No. 61/794,133, filed on Mar. 15, 2013.

(51) Int. Cl. G09B 7/00

(52) U.S. Cl. CPC G09B 7/00
USPC 434/353

(57) ABSTRACT

Techniques for enhancing an individual's knowledge of civics topics in an interactive manner are described herein. In particular implementations, a user may interact with a computing device, such as a smart phone, tablet computer, or laptop computer, to take a test related to civics topics and to view information about others that have taken the test. For example, a user may view an average test score of others of a particular geographical region or group, a test score of an elected representative, a test score of a friend, and so on.

### RELATED APPLICATIONS

This application claims the benefit of U.S. Provisional Patent Application No. 61/794,133, filed on Mar. 15, 2013, the entire contents of which are incorporated herein by reference.

### BACKGROUND

Many individuals strive to improve their knowledge of civics topics. For example, an individual preparing for a citizenship test may study practice questions from a test preparation book to learn topics, such as history, government, current affairs, and so on. While this strategy may enhance an individual's knowledge to some degree, the process may often leave the individual uninterested, resulting in decreased productivity in studying the topics. As more individuals become interested in civics topics, there is an increasing need to enable those individuals to enhance their knowledge while maintaining their interest in civics topics.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture to facilitate an interactive experience with civics testing.

FIGS. 2A-2C illustrate example interfaces to facilitate civics testing in a practice test mode.

FIGS. 3A-3C illustrate example interfaces to facilitate civics testing in a competition mode.

FIGS. 4A-4C illustrate example interfaces to view and/or provide information associated with users that have taken a civics test.

FIG. 5 illustrates an example process to utilize a civics test score.

### DETAILED DESCRIPTION

This disclosure describes architectures and techniques directed to enhancing an individual's knowledge of civics topics in an interactive manner. In particular implementations, a user may interact with a computing device, such as a smart phone, tablet computer, or laptop computer, to take a test related to civics topics and to view information about others that have taken the test. For example, a user may view an average test score of others of a particular geographical region or group, a test score of an elected representative, a test score of a friend, and so on. In some instances, the techniques described herein may enable a user to interact with others that are studying for a civics test, thereby enhancing the user's testing experience. One implementation of the techniques described herein may be understood in the context of the following illustrative and non-limiting example.

Joe is studying to become a citizen of the United States. As part of his application for citizenship, Joe is required to pass a citizenship exam that assesses his knowledge of topics including U.S. history, government, foreign policy, economics, and current affairs. To prepare for the exam, Joe interacts with a test preparation application on his tablet computer to view practice questions for these topics and to provide answers to the questions. Upon completing a practice exam, Joe is given the option to view score-based information for others that have taken the practice exam or a similar practice exam. The information may include, for example, an average test score of residents of his state or elected representative, a test score of an elected representative of his state (e.g., a state senator, etc.), a test score of his friend, and so on. In this example, Joe selects an option to view the average score of residents of his state. The average score is then presented on his tablet computer to enable Joe to view his progress relative to others that have taken a practice exam. By viewing his progress relative to others, Joe may maintain interest in studying for the citizenship exam.

In some instances, the techniques described herein may enable an individual to study civics topics in an interactive manner. For example, by enabling an individual to view scores of other individuals or groups of individuals that have taken a civics practice test, the individual may compare his knowledge with that of other individuals. This may enhance a user's experience in studying civics topics.

The techniques are described herein in the context civics topics, such as history, government, foreign policy, economics, current affairs, and so on. However, these techniques may alternatively, or additionally, be applicable to mathematics, science, English, or any other academic subject.

In some embodiments, the techniques described herein make information of one individual available to another individual. For example, the techniques may allow an individual to view a test score of another individual. It should be understood that information of one individual that is made available to another individual is done so with the explicit authorization of the individual and/or in an anonymized manner that removes identifying information of the individual.

This brief introduction is provided for the reader's convenience and is not intended to limit the scope of the claims. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Example Architecture

FIG. 1 illustrates an example architecture 100 in which techniques described herein may be implemented. The architecture 100 includes a civics testing service 102 (hereinafter “the testing service 102”) configured to communicate with one or more devices 104 (hereinafter “the device 104”) to facilitate an interactive experience with civics testing. For example, the testing service 102 may enable one or more users 106 (hereinafter “the user 106”) associated with the device 104 to take a civics test on the device 104 and/or view information related to others that have taken the civics test.

In some instances, the civics testing techniques described herein may be used to help a user study for and/or take a civics-based test. For example, the techniques may enable a user to study for and/or take a citizenship test for a country, a civics test in a school environment, an assessment test for a competition related to civics topics, and so on. In one example, a teacher may receive test scores of students of a class to assess the students understanding of civics topics. In another example, a user may prepare for a civics-based competition that includes a test on civics topics.

The testing service 102 may include one or more computing devices, such as one or more desktop computers, laptop computers, servers, and the like. The one or more devices may be configured in a cluster, data center, cloud computing environment, or a combination thereof. In one example, the one or more devices provide cloud computing resources, including computational resources, storage resources, and the like, that operate remotely to the device 104.

The one or more devices of the testing service 102 may include one or more processors 108 and memory 110. The memory 110 may include software functionality configured as one or more “modules.” The term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions and modules are described herein as being implemented by software and/or firmware executable on a processor, in other embodiments, any or all of the modules may be implemented in whole or in part by hardware (e.g., as an ASIC, a specialized processing unit, etc.) to execute the described functions. As illustrated in FIG. 1, the memory 110 includes a test module 112 and a feedback module 114.

The test module 112 may be configured to administer one or more civics tests 116 to the user 106 through the device 104. For example, the module 112 may provide civics questions to the device 104 and receive answers to the questions. As the one or more civics tests 116 are administered to the user 106, or after completion, the module 112 may determine a test score for the user 106. The test score may be based on a level of difficulty associated with each questions, an order in which questions are presented, and so on. A test score for a user may be stored in a score data store 118. In some instances, the module 112 may determine a general score for the user 106 based on scores for multiple tests. The test module 112 may serve as a central resource for multiple users by administering civics tests to multiple users.

The one or more civics test 116 may comprise an official or practice test. A practice test may generally comprise any number of questions to assist a user in preparing for an official test. A practice test may include, for example, questions from previous official tests, questions provided by an individual (e.g., teachers, leaders, users associated with the testing service 102, etc.), questions formulated from analyzing previous official tests, and so on. Meanwhile, an official test may comprise a test that is administered for some type of official assessment, such as a citizenship test, school test, etc. The one or more civics tests 116 may comprise questions related to civics topics, such as history, government, foreign policy, economics, current affairs, and so on. In the example architecture 100 of FIG. 1, a test data store 120 stores the one or more civics tests 116. However, in other examples the test data store 120 stores a collection of questions that are used to formulate a civics test.

In some instances, the test module 112 manages a test on a question-by-question basis (e.g., adaptive test). For example, a civics test may be administered in an adaptive manner such that an answer to one question determines the next question that will be presented. In one example, the test module 112 may provide a more difficult question (relative to a current question) when the current question is answered correctly and provide a less difficult question when the current question is answered incorrectly. Further, in some instances the test module 112 provides an entire test or group of questions at a time. The test module 112 may manage questions such that a same question is not presented to the user 106 within any number of tests. This may enable the user 106 to prepare for a variety of questions.

The feedback module 114 may be configured to provide information associated with one or more users that have taken one or more civics tests or questions. The information may be provided as a user takes a test, upon completion of a test or question, and/or at any time before or after taking a test. The information may include, for example:
A test score of a user that has taken a civics test, such as a test score of a friend, an elected/appointed person of a governing body (e.g., state senator, judge, president, governor, etc.), a candidate running to be elected/appointed over a governing body, a person of a particular school or school district (e.g., superintendent, student, teacher, counselor, etc.), and so on. A governing body may govern an area in which a user that is requesting information (e.g., a recent test taker) is located. In some instances, the feedback module 114 may determine/identify a location (e.g., a geo-location, address, etc.) of a user that is requesting information and provide a score of a person that is associated with the location. For example, the feedback module 114 may provide a test score of a politician that is associated with a state in which the user resides.
An average score for users of a particular characteristic, such as an average score for users that attend a same school, an average score for users located within a particular geographical region (e.g., school district, voting district, city, state, country, etc.), an average score of users of one or more particular demographic characteristics (e.g., age, gender, ethnicity, social status, income level, etc.), and so on.
A ranked list of a group of users, such as a group of users of a particular characteristics, a group of friends, and so on. The list may be based on test score of those within the group.
A graph of test scores, such as a graph of a score average over time (e.g., a graph indicating how a user's average test score changes with respect to time).
An amount of time a user spends on a question or test, such as an amount of time per question or test, an average amount of time per question or test, a total amount of time spent across multiple tests or questions, etc.
A comment from another user that has taken a test or a question from the test, such as a comment from a friend, a teacher, an author of the test or question, and so on. For example, a friend may leave a comment for a question about local government structure that indicates a formula for remembering the local government structure.
Suggested topics to study. For example, the feedback module 114 may provide a message indicating that a user should spend more time studying about current affairs. The message may be based on the user's previous test answers. For example, the module 114 may recommend that a user study more about current affairs when the user has incorrectly answered a particular number of current affair questions.

The feedback module 114 may also be configured to provide a map to enable a user to view information associated with users that have taken a civics test or question. The map may show one or more geographical areas defined by school district boundaries, city boundaries, county boundaries, state boundaries, country boundaries, voting boundaries (e.g., electoral district boundaries, etc.), and so on. In one example, the map may include icons representing users that are associated with test scores. In some instances, the map includes different types of icons for different types of users. For example, state senators may be associated with blue icons, whereas friends of a social networking site may be associated with red icons. Upon selecting an icon, a score or other score-based information may be presented.

Meanwhile, the device 104 may comprise a laptop computer, a desktop computer, a smart phone, an electronic reader device, a mobile handset, a personal digital assistant (PDA), a portable navigation device, a portable gaming device, a tablet computer, a watch, a portable media player, and the like.

The device 104 may be equipped with one or more processors 122 and memory 124. The memory 124 may include a client application 126 (e.g., module) configured to interface with the user 106 and perform other functionality. For instance, the client application 126 may output one or more questions to the user 106 (as shown by illustrative user interface 128), receive input from the user 106 via the user interface 128 (e.g., answers to the one or more questions), and/or output information associated with the user's 106 test score or other users' test scores (e.g., an average score for a user over time) (as shown by illustrative user interface 130). In many instances, the client application 126 operates in cooperation with the testing service 102. For example, the client application 126 may receive a question from the testing service 102, display the question, receive input from the user 106, provide a user answer to the testing service 102, and receive a further question that is determined by the testing service 102.

Although in the example architecture 100 of FIG. 1 the testing service 102 primarily manages administration of a civics test and information related to one or more test scores, one or more of these functions may alternatively, or additionally, be performed by the device 104. As such, in some instances the testing service 102 may be eliminated entirely and/or replaced by the device 104.

The memory 110 and/or 124 (as well as all other memory described herein) may include one or a combination of computer storage media (e.g., computer-readable storage media). Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media is limited to non-transitory media.

The architecture 100 may also include one or more networks 132 to enable the civics testing service 102 and the device 104 to communicate with each other. The one or more networks 132 may include any one or combination of multiple different types of networks, such as cellular networks, wireless networks, Local Area Networks (LANs), Wide Area Networks (WANs), and the Internet.

### Example Interfaces

FIGS. 2-4 illustrate example interfaces that may be presented to a user to facilitate an interactive experience with civics testing. The interfaces may be displayed through a browser, an application, and so forth. To illustrate, the interfaces may be displayed through an online site associated with civics testing or through an application running locally on a client device. In the examples of FIGS. 2-4, the interfaces are provided through the device 104.

FIGS. 2A-2C illustrates example interfaces 202-206 to facilitate civics testing in a practice test mode. In particular, through the interface 202 in FIG. 2A, a user may select a test mode (e.g., practice, simulated, or competition) through radio controls 208-212. The practice test mode allows a user to take a practice test and view answers, explanations, and/or hints, the simulated test mode allows a user to take a timed simulated practice test without viewing answers or explanations, and the competition mode allows a user to view information of others that are taking or have taken a practice test. When the competition mode is selected, a user may input another user's name or other identifying information through an input field 214 so that information of the other user may be obtained. Although testing features are described as being associated with a specific testing mode, any number of testing features may be associated with any testing mode. Further, although not illustrated, other testing modes may similarly be implemented, such as an official testing mode that allows a user to take an official test. In another example, a game mode may be implemented to enable a user to earn points or compete against other users or a computer. The points may be used to achieve rankings, awards (e.g., displayable graphical badges), merchandise, unlock levels, and so on. In the example interfaces 202-206 of FIGS. 2A-2C, the practice test mode is selected and a begin test button 216 is selected to begin a practice test.

Through the interface 204 in FIG. 2B, a user may view a question in the practice mode. Here, the interface 204 provides a question and selectable answers to the question (e.g., buttons A-D). This may enable the user to provide an answer through the device 104. As also illustrated, the interface 204 may include a hint button 218 that enables the viewing of content (e.g., displayed in a window) 220 including a hint to the current question (e.g., a suggestion or additional information that may be useful in answering the question).

Through the interface 206 in FIG. 2C, an explanation for an answer may be presented to a user. The interface 206 may be presented after a user has submitted an answer. The explanation may provide details about the correct answer for a question. In this example, the user has answered the question incorrectly. In some instances, the explanation is presented whenever an incorrect answer is given, while in other instances the explanation may always be presented. As also illustrated in FIG. 2C, the interface 206 may include a previous button 222 to navigate to a previous question and a next button 224 to navigate to a next question.

FIGS. 3A-3C illustrates example interfaces 302-306 to facilitate civics testing in a competition mode. In particular, through the interface 302 of FIG. 3A, a user may select the competition mode and input identifying information for one or more users through the input field 214. The identifying information may include a user's name, telephone number, address, email address, position (e.g., state senator), or any other identifying information.

The example interface 304 of FIG. 3B may be presented upon submitting an answer to a question in the competition mode. The interface 304 may enable a user to view information for users that are identified in the input field 214. In this example, the user has requested to receive information for his friend Tom Smith and his state senator. As illustrated at 308 and 310, Tom did not answer question 4 correctly while the user's state senator did answer question 4 correctly. Through buttons 312 and 314, the user may view more detailed information for Tom Smith and the user's state senator, as discussed below in reference to FIG. 3C. Although not illustrated in FIG. 3B, the interface 304 may additionally, or alternatively, present comments of other users and/or present a field to enable the user to provide a comment. The comment may provide additional information about a question or a test, such as information about how to remember a particular answer to a question, information identifying a content item to study for assistance on a topic, and so on.

Upon selecting the button 312 in the interface 304, the interface 306 of FIG. 3C may be presented to the user. The interface 306 may include graphs 316 and 318 related to test scores for Tom Smith and the user. In particular, the graph 316 shows how a test score has changed for Tom and the user through various questions of the test. Meanwhile, the graph 318 shows a score average with respect to time across all tests that have been taken by Tom and the user. The buttons 222 and 224 of FIGS. 3B and 3C may allow the user to proceed to a previous or next question.

FIGS. 4A-4C illustrates example interfaces 402-406 to view and/or provide information associated with users that have taken a civics test. In particular, the interface 402 of FIG. 4A includes a button 408 to compare a user's score with one or more scores of other users (an example comparison is discussed in reference to FIG. 4B), a button 410 to view a map of users that have taken a civics test (an example map is discussed in reference to FIG. 4C), a button 412 to challenge a user to compete in civics testing, and a button 414 to share a score with a user. In the example illustrated in FIG. 4A, the interface 402 is provided after the user has completed a civics test. However, the interface 402 may be presented at any time.

Upon selecting the button 412, a user may invite another user to compete for a highest test score (e.g., a highest average test score, a highest score on a particular test, etc.). In some instances, updates on the users' scores may be provided to the users as the users complete practice tests. Meanwhile, selection of the button 414 may enable the user to share a test score (e.g., average test score, recent test score, etc.) with another user through a social networking site, a blog, a notification, and the like. A notification may comprise an email, text message, or any other type of notification.

In some instances, the selection of the button 408 may cause a filtering tool to appear to enable a user to specify one or more criteria. The filtering tool may include any number of interface elements (e.g., drop down menus, radio controls, input fields, etc.). The one or more criteria may allow the user to view scores of other users, such as users of a particular group (e.g., users of a same demographic characteristic, preference, geographical region, school district, etc.), an average score of other users, and so on.

The interface 404 of FIG. 4B shows one example of information that may be presented upon selection of the button 408 in the interface 402. The interface 404 includes a ranked list of users based on test scores of the users. In this example, the ranked list includes friends of the user that have taken a civics test and have provided authorization for their score to be made available to others.

Meanwhile, the interface 406 of FIG. 4C shows one example map that may be presented upon selection of the button 410 in the interface 402. In this example, the map shows the United States with icons 416-420 representing different individuals that are associated with civics test scores. Selection of the icons 416-420 may cause score information for the individual to appear. For example, selection of the icon 416 may cause a window 422 to be presented providing a test score of the user's friend Tom Smith, selection of the icon 418 may cause a window 424 to be presented providing a test score of the user's state senator, and selection of the icon 420 may cause a window 426 to be presented providing the user's test score. In some instances, the user may also select a geographical region through the interface 406 to view information for that region. In one example, the user may select the state of New York and view a window 428 including an average test score for that state. Further, in one example, the map may show states in different colors to indicate an average score for the different states.

The interface 406 may also include a drop-down menu 430 and an update map button 432 to change viewing options of the map. The menu 430 may allow a user to filter different types of users that are represented on the map. For example, the user may filter users based on a particular preference, demographic characteristic, and so on.

### Example Process

FIG. 5 illustrates example process 500 for employing the techniques described herein. For ease of illustration the process 500 is described as being performed in the architecture 100 of FIG. 1. For example, one or more of the individual operations of the process 500 may be performed by civics testing service 102 and/or the device 104. However, the process 500 may be performed in other architectures. Moreover, the architecture 100 may be used to perform other processes.

The process 500 (as well as each process described herein) is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the individual operations may be omitted.

At 502, the testing service 102 may cause a civics test to be provided through the device 104. In some instances, the civics test comprises a practice test to assist a user in preparing for an official test (e.g., a citizenship test), while in other instances the civics test comprises an official test. The civics test may be provided by sending one or more questions to the device 104 and receiving one or more answers from the device 104. The answers may be received at the device 104 through an interface. In one example, questions of the civics test are sent to the device 104 one-by-one in an adaptive manner that adapts to answers of a user. In another example, an entire test or portion of a test is sent to the device 104. In some instances, the testing service 102 may collect test answers from a plurality of devices and store the answers for processing and/or retrieval.

At 504, the testing service 102 may identify or determine a civics test score for one or more users that have taken a test. The test score may be based on one or more answers provided by the user 106, a level of difficulty of each question, an order of the questions, and so on. For example, when the test is an adaptive test, a test score may be determined based on when incorrect answers are provided by a user.

At 506, the testing service 102 may utilize one or more civics test scores. For example, at 508, the testing service 102 may cause score-based information associated with one or more users that have taken a civics test to be output. To illustrate, the testing service 102 may output information indicative of a civics test score of a user relative to one or more civics test scores of a group of users of one or more particular demographic characteristics, information indicative of a civics test score of a user relative to a civics test score of a person that is elected or appointed to a governing body or is a candidate campaigning to be elected or appointed to the governing body, information indicative of the civics test score of the user relative to one or more civics test scores of users of a particular geographical area, and so on. In another illustration, the testing service 102 may determine a ranking for a plurality of users based on civics test scores for the plurality of users and cause the ranking to be output. In one example, the ranking is output on a map in response to selection of an icon representing a user that has taken a civics test.

Alternatively, or additionally, at 510, the testing service 102 may cause a map to be output with information associated with a civics test score of a user. The map may show one or more geographical areas defined by at least one of school district boundaries, city boundaries, county boundaries, state boundaries, country boundaries, or voting boundaries. In one example, the map shows a geographical area of a user that has just taken a civics test and has requested to view the map. The map may include one or more icons associated with one or more users that have taken a civics test. Upon selecting an icon, information associated with a test score may be provided. In some instances, the map may be filtered based on user input so that the map only displays icons for users that are associated with particular characteristics.

At 512, the testing service 102 may enable a user to challenge another user to compete for a best civics test score (e.g., highest test score). Here, the user may send a notification requesting that the other user take one or more civics tests to compete for a best score.

At 514, the testing service 102 may enable a user to share a civics test score with another user. The test score may be shared through a social networking site, a blog, a notification (e.g., email, text message, etc.), and the like. In some instances, the test score may be shared along with information indicating how the user's test score has changed over time. Such information may be presented in a graph.

At 516, the testing service 102 may suggest one or more civics topics for a user to study. For example, the testing service 102 may suggest that a user study more about current affairs based on the user's answers to current affairs.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
under control of one or more computing devices configured with specific executable instructions,
causing a civics test to be provided to a user;
identifying a civics test score for the user that is based at least in part on input of the user in response to one or more questions of the civics test; and
causing display of information indicative of the civics test score of the user relative to one or more civics test scores of one or more other users.

2. The method of claim 1, wherein causing a civics test to be provided to the user comprises causing a practice test to be provided to assist the user in preparing for a citizenship test.

3. The method of claim 1, further comprising:
before causing display of the information, causing the civics test to be provided to the one or more other users;
receiving input of the one or more other users for the civics test; and
determining the one or more civics test scores of the one or more other users.

4. The method of claim 1, wherein the information is indicative of the civics test score of the user relative to one or more civics test scores of a group of users of one or more particular demographic characteristics.

5. The method of claim 1, wherein the information is indicative of the civics test score of the user relative to a civics test score of a person that is elected or appointed to a governing body or is a candidate running to be elected or appointed to the governing body, the governing body governing an area in which the user is located.

6. The method of claim 1, wherein the information is indicative of the civics test score of the user relative to one or more civics test scores of users of a particular geographical area.

7. The method of claim 1, wherein the one or more computing devices are configured as a remote resource or as one or more client devices.

8. The method of claim 1, wherein causing the civics test to be provided to the user comprises causing the one or more questions of the civics test to be output on the one or more other computing devices in a manner that adapts to one or more answers of the user.

9. The method of claim 1, further comprising, after identifying the civics test score of the user, enabling the user to share the civics test score of the user with another user.

10. The method of claim 1, further comprising:
after identifying the civics test score of the user, enabling the user to request that a another user take the civics test,
wherein causing display of the information comprises causing display of, after the other user has taken the civics test, the civics test score of the user along with a civics test score of the other user.

11. One or more computer-readable storage media storing computer-readable instructions that, when executed, instruct one or more processors to perform operations comprising:
causing a civics test to be provided to each of a plurality of users;
determining a civics test score for each of the plurality of users based at least in part on one or more answers of the civics test for each of the plurality of users; and
causing display of a map with an icon representing at least one user of the plurality of users, selection of the icon causing display of the civics test score for the at least one user of the plurality of users.

12. The one or more computer-readable storage media of claim 11, wherein the civics test includes one or more questions that relate to citizenship topics.

13. The one or more computer-readable storage media of claim 11, wherein the operations further comprise:
after determining the civics test scores for the plurality of users, determining a ranking for the plurality of users based at least in part on the civics test scores for the plurality of users; and
causing display of the ranking on the map.

14. The one or more computer-readable storage media of claim 11, wherein the at least one user of the plurality of users comprises a person that is associated with a governing body.

15. The one or more computer-readable storage media of claim 11, wherein the operations further comprise:
causing one or more of the plurality of users to be selected for a comparison,
wherein causing display of the map comprises causing display of the map with one or more icons that represent the one or more selected users.

16. The one or more computer-readable storage media of claim 11, wherein the map shows one or more geographical areas defined by at least one of school district boundaries, county boundaries, state boundaries, country boundaries, or voting boundaries.

17. One or more computer-readable storage media storing computer-readable instructions that, when executed, instruct one or more processors to perform operations comprising:
causing a civics test to be provided to a user through a client device;
identifying a civics test score for the user that is based at least in part on input of the user in response to one or more questions of the civics test; and
causing output of information indicative of the civics test score of the user relative to one or more civics test scores of one or more other users.

18. The one or more computer-readable storage media of claim 17, wherein the information is indicative of the civics test score of the user relative to one or more civics test scores of a group of users of one or more particular demographic characteristics.

19. The one or more computer-readable storage media of claim 17, wherein the information is indicative of the civics test score of the user relative to a civics test score of a person that is elected or appointed to a governing body or is a candidate running to be elected or appointed to the governing body.

20. The one or more computer-readable storage media of claim 17, wherein causing output of the information comprises causing the information to be displayed on a map that displays a particular geographical area that is associated with the user.
